(19) United States
(12) Patent Application Publication
(10) Pub. No.: US 2005/0108300 A1
(43) Pub. Date: May 19, 2005

(54) Method for the management of local client cache buffers in a clustered computer environment

(75) Inventors: Iain B. Findleton, Baie D'Urfe (CA); Xinliang Zhou, Longueuil (CA)

Correspondence Address: OGILVY RENAULT, 1981 MCGILL COLLEGE AVENUE, SUITE 1600, MONTREAL, QC, H3A2Y3, CA

(73) Assignee: TERRASCALE TECHNOLOGIES INC.

(21) Appl. No.: 10/714,401

(22) Filed: Nov. 17, 2003

(51) Int. Cl. G06F 12/00

(52) U.S. Cl. 707/203

(57) ABSTRACT

A method for retrieving data elements from a shared medium by a client computer is provided. The shared medium maintains a main list of data version information associated with each data element, while the client maintains another locally-stored list containing all previously retrieved data elements associated with their respective data version. The client computer checks whether there is a record for a data element in the locally-stored list and if so, sends the data version associated with it to the shared medium. The shared medium compares the data version received with the data version stored in its main list and if the two match, sends a confirmation to the client computer. If the data versions do not match, the shared medium sends a new copy of the data element and a new data version to the originating client computer, such that the client computer updates its locally-stored list.

### CROSS-REFERENCE TO RELATED APPLICATIONS

The application is cross-referenced to U.S. patent application entitled “Method for Retrieving and Modifying Data Elements on a Shared Medium” filed simultaneously herewith and with agent docket number 16764-2US, the specification of which is hereby incorporated by reference.

### FIELD OF THE INVENTION

The invention relates to improvements to client computers accessing a common storage medium. More specifically, it relates to a method for efficient management of local client computer buffers accessing data on a common storage medium.

### BACKGROUND OF THE INVENTION

The growth in the deployment of large agglomerations of independent computers as computational clusters has given rise to the need for the individual computers in these clusters to access common pools of data. Individual computers in clusters need to be able to read and write data to shared storage devices and shared display devices. Because a cluster may be assembled from many thousands of individual computers, each of which generates data access requests on an independent basis, enabling shared access to a common data pool requires the deployment of a scheme that ensures that the data retrieved by some of the computers In the cluster is not corrupted by the incidence of data modification activity produced by other computers in the cluster.

One typical configuration that is encountered during clustered computer deployments comprises a storage medium, such as a single disk drive or a memory unit or a digital display device with a so called frame buffer design, connected via a data transport network to a number of independent computers. The function of the computers is to process data that is held on the storage medium in some fashion, during the course of which activity the data on the storage medium is being both read and written by the computers.

The computers process the data on the shared medium asynchronously. There is no supervisory mechanism in place that has the effect of granting the individual computers the right to access the data on the storage medium in a fashion that ensures even the integrity of data retrieval.

Any transaction produced by one of the cluster computers is characterized by its occupancy in a time window that begins with the time the transaction is initiated by the computer, and spans the combined time periods required to transport the transaction to the storage medium, execute the transaction, and to initiate transport of the response to the transaction back to the computer. During this time span one or more of the other computers sharing the storage medium could have initiated a data modification transaction that is characterized by a time of initiation that is after the time of initiation of the original transaction but within its time span. Without intervention, the data on the storage medium could conceivably be modified during the time that it is being prepared from transmission to the original computer.

Other scenarios that have the potential for producing undesirable results from transactions produced in a clustered computer environment include the arrival at the storage medium of out of order transactions, as when a data retrieval transaction followed by a data update transaction for the same computer arrive In reverse order, or when a data update transaction is executed while multiple other computers are in the process of retrieving the same data element.

The traditional approach to addressing the problem of shared access to data element on a shared storage medium is to Implement a scheme of locks that have the effect of serializing access to the data element by forcing the transaction initiators to wait until it gains exclusive access to a lock on the data element. The specific implementation of the locking mechanism is dependant on a variety of factors related to the nature of the computing application being used, the volatility of the data stored on the storage medium, and the scale of the computer cluster in use. Regardless of the specifics of the implementation, all of the schemes found in prior art have the effect of imposing on the transaction initiator the requirement to schedule its transactions in a manner that ensures atomically correct access to the data element in question.

FIG. 1 shows one approach to the resolution of the shared data access problem. A Meta-Data Controller (MDC) node, or nodes, is added to the cluster of computers that make up the system. It is the function of the MDC to police the access to data elements by scheduling transaction requests originated by the client of the Shared Storage Medium Controller (SSMC) in a manner that ensures that clients receive data elements in a state that is devoid of the possible data corruption problems that could result from the execution of multiple simultaneous transaction requests.

Application programs running on the computers that are clients of the Shared Storage Medium Controller will typically wish to cache data elements in their local memory with the view of gaining more rapid access to the data elements than would be possible through the mechanism of sending a data access transaction request over the computer communication network and waiting for the response to return. The speed of access to data elements in a local memory cache has historically been much faster than the speed of access to data elements stored on either locally connected storages devices, such as disk drives, or stored on network connected storage devices. This is due to the fact that local memory speed supports a rapid access rate and low transaction latency that are difficult to match in performance with mechanical storage devices such as the disk drive. The introduction of network connected storage devices aggravates the issue of latency of transactions because of the need to go out across a communications network, execute the transaction and then retrieve the result. Network latencies are typically larger than those of locally connected devices.

Operations on cached data by applications running on the client nodes of the cluster proceed under the assumption that the copy of the data in the local client memory cache is consistent with the original data elements stored on the Shared Storage Medium (SSM). Since, in a shared access environment, the original data elements can at any time become modified by other clients, a mechanism is needed to ensure that the contents of the local client cache is consistent with the contents of the data elements on the SSM at all times.

In prior computer art, schemes for ensuring the consistency of local cache have been developed that involve the use of locks, as with a MDC, the use of push mechanisms, wherein the SSMC signals the clients when a change is made to the data elements it holds, and the use of poll schemes, wherein the clients periodically poll the SSMC as to the status of the data elements and reload any changed items as required.

All of the schemes that are found in prior art that address the issue of local cache consistency in a clustered computer environment suffer from the problem that they impose on the network an additional transaction load associated with each application originated transaction. The additional network load arises because some form of signaling must go on between the SSMC and the clients, or between the SSMC and the MDC and the clients, in order to ensure that the local client cache is indeed a valid copy of the data elements held on the SSM.

In the case of an MDC based approach, an application originated transaction generates the following additional transactions on the network, beyond the actual original transaction:
1. A transaction to the MDC requesting a lock on the data elements
2. A transaction from the MDC to the SSMC implementing the lock
3. A transaction from the MDC to the client issuing the lock
4. A transaction from the client to the MDC releasing the lock
5. A transaction from the MDC to the SSMC destroying the lock

In a push scheme, the following transactions are typical:
1. A transaction from the client to the SSMC requesting the data elements

2. A transaction from the SSMC to all clients notifying them of a change to the data elements

3. Transactions from the clients to the SSMC requesting new copies of the data elements

In poll schemes, a client will read the data elements into a local cache, then, prior to each operation on the cached data elements, will query the SSMC as to the status of the data elements. If a change has occurred, the client will reload the data from the SSMC.

In the context of a shared access by many clients to a network connected SSM which does not involve the use of an MDC it is evident that a poll based scheme could result in the number of poll transactions on the network growing without bound until all applications are brought to a standstill pending the results of cache revalidation operations. Even when push and MDC based schemes are employed, as the size of the cluster grows, the network load associated with cache revalidation operations eventually grows to the level that the network has no bandwidth left for actual application work.

There exists therefore a need for a method for ensuring that the contents of the local cache are always consistent with the contents of the shared storage medium at all times.

Moreover, as computer networks are expected to grow in size, there exists a need for a method to ensure local cache consistency in a clustered computer environment that is scalable and does not increase network traffic.

### SUMMARY OF THE INVENTION

According to a first broad aspect of the present invention, there is provided a method for retrieving data elements from a shared medium by a client computer, the shared medium maintaining a main list of data version information associated with the data elements. The method comprises the steps of: the client maintaining a locally-stored list containing previously retrieved data elements associated with their data version; the client reading from said locally-stored list data version associated with the data element and sending a request over a data network including the data version to the shared medium; then, if the data version received from said client does not match the main list data version associated with the data element, the shared medium sending to the client a new copy of the data element and a new data version, the client updating the locally-stored list with said new copy of the data element and the new data version; if the data version received from the client matches the main list data version associated with the data element, the shared medium sending to the client confirmation that the locally-stored data element associated with the data version is valid. The method therefore allows reducing the transfer of copies of data elements between the shared medium and the client and the amount of network load needed to retrieve data elements from the shared medium.

According to a second broad aspect of the present invention, there is provided a method for maintaining a main list of data version Information associated with data elements on a shared medium, the data version information being used for data retrieval. The method comprises: creating a list of data structures identifying data elements on the shared medium and the data version information; receiving a request on a data network for writing at least one of the data elements; following modification to the at least one of the data elements, giving a new data version to the at least one of the data elements that was modified.

### BRIEF DESCRIPTION OF THE DRAWINGS

These and other features, aspects and advantages of the present invention will become better understood with regard to the following description and accompanying drawings wherein.

FIG. 1 is a schematic diagram of the mechanism typically found in the prior art for addressing the issues of multiple client access to a shared storage device.

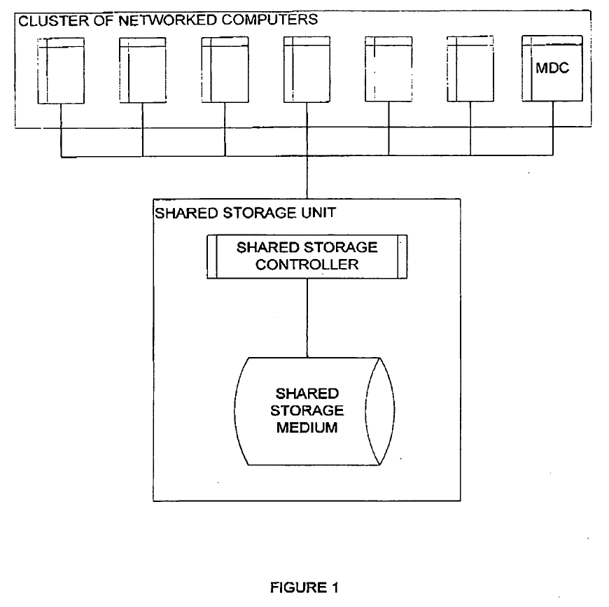

FIG. 2 is a schematic diagram of a cluster of computers implementing shared access to a writable storage medium according to a preferred embodiment of the present invention.

FIG. 3 is a block diagram of a method for maintaining local cache consistency of a client accessing a shared medium according to a preferred embodiment of the present invention.

FIG. 4 is a block diagram of list structures used for maintaining local cache consistency according to a preferred embodiment of the present invention.

### DETAILED DESCRIPTION OF THE PREFERRED EMBODIMENT

ACRONYMS
[ . . . ]SCSI Small Computer System Interface
[ . . . ]TCP Transmission Control Protocol
[ . . . ]IP Internet Protocol
[ . . . ]iSCSI Internet Small Computer System Interface
[ . . . ]MDC Meta-data Controllers
[ . . . ]SASS Shared Access Scheduling System
[ . . . ]SSM Shared Storage Medium
[ . . . ]SSMC Shared Storage Medium Controller

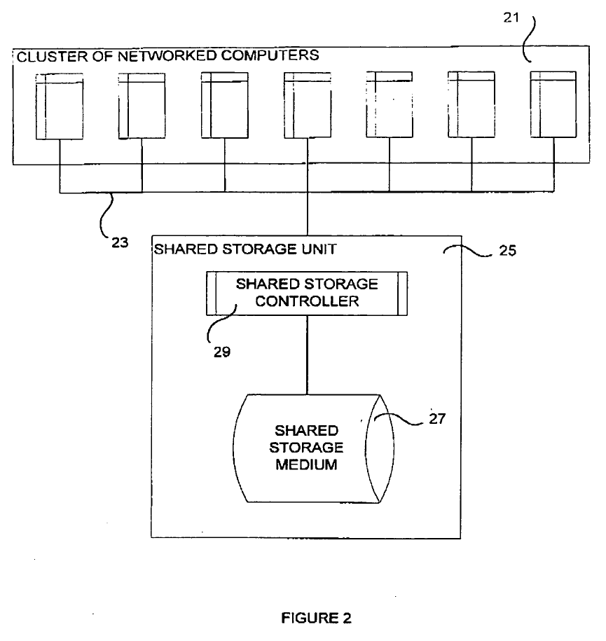

FIG. 2 illustrates a possible and preferred embodiment of the present invention. A cluster of client computers 21 are connected to a shared storage unit 25 via a computer communications network 23. The SSM 27 itself is a general purpose computer system, or system of general purpose computers, that is running SASS that implements a scheme of scheduling of Input/output transactions on the SSM 27. SASS uses a concept of data elements leases, which will be described below, on the SSM 27 to schedule asynchronously generated client transactions on the data elements held on the SSM 27 to ensure that client computers 21 always receive, as the result of a transaction, a copy of the data element as found on the SSM 27 at the time the client request is received at the SSMC 29.

Data Element Leases

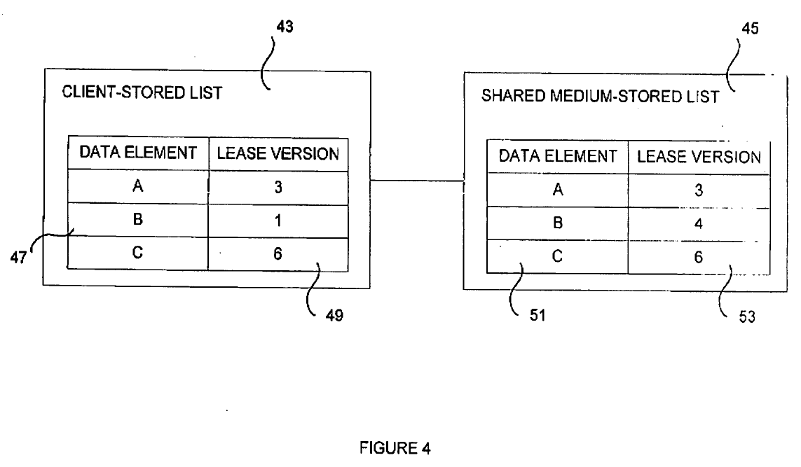

In reference to FIG. 4, a lease is a data structure that contains information about a data element or data elements stored on shared storage medium. SASS implements leases for data elements that are stored on the SSM 27. A lease on a data element 47 stored in the local cache memory of a client computer 21 contains information identifying the original data element 51 on the SSM 27 and a version number 49 for the data element or elements 47 covered by the lease. The information identifying the data element for purposes of locating it on the SSM 27 may be a single address, an address range of contiguous storage blocks, multiple address ranges corresponding to non-contiguous storage blocks, etc.

The leases for data elements 47 held in the local client's memory cache are held in a list 43. Leases in the locally-stored client list cover only those data elements 47 that the client 21 has accessed on the SSM 27. A single lease can cover one or more data elements 47. A lease management scheme is employed that collects the leases for logically adjacent data elements 47 into a single lease.

Client Transactions

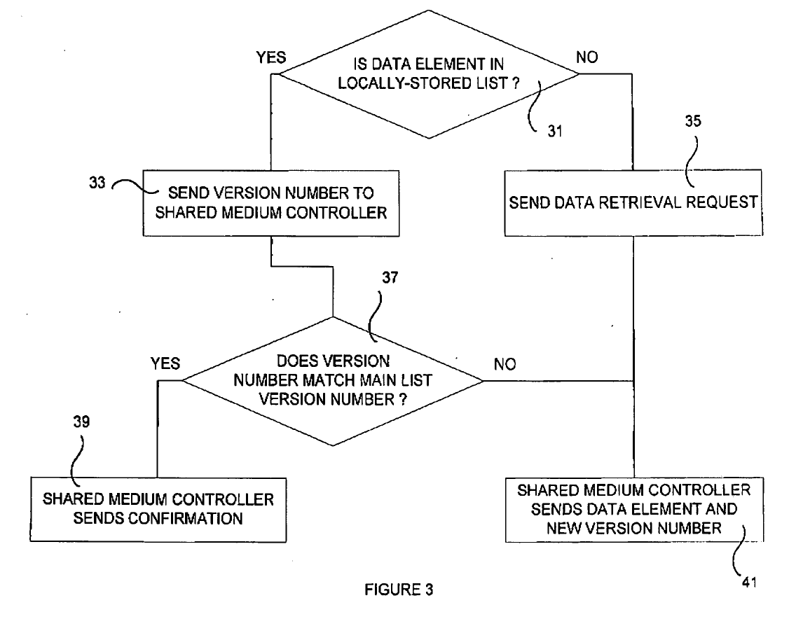

Now referring to FIG. 3, a client transaction request will be described. When an application running on a client computer 21 has the need to access a data element stored in its local memory cache, either for reading or for writing, as per step 31, the client-stored lease list 43 is interrogated to find an existing lease 49 that covers the element 47. If a lease exists, the lease version number 49 is sent 33 to the SSMC 29. If the lease number 49 sent to the SSMC 29 is identical to the lease version number 53 of the data element 51 in the lease list 45 managed by the SSMC 29, the SSMC replies 39 with a message indicating that the copy of the data element 47 on the client side is valid. If the lease number 49 sent to the SSMC 29 does not match that of the lease version number 53 held on the SSMC 29, then the SSMC 29 sends back 41 a new copy of the data element 51 and its new version number 53.

If no lease is found in the client-stored lease list 43, a new record is created on the client for the data element 47, and the lease version number 49 is set to zero. The client then sends a request 35 to the SSMC 29 with the zero version number, which always causes the SSMC 29 to reply with a new copy of the data element 51 as well as its version number 53.

Following the above series of operations, the client computer 21 will have in its local memory cache a valid copy 47 of the data element whose original data 51 are held on the SSM 27.

Clients may create new data elements by writing data to the SSM 27 directly, or by reading in data elements 51 on the SSM 27, modifying them and writing them back to the SSM 27. In the case of the creation of new data elements, clients need not concern themselves with the version number 53 on the SSM 27 of the new data element being written. Before creating a new data element, the client will have, through the auspices of an allocation mechanism such as a file system, gained exclusive access to the data element location on the SSM 27. When the SSMC 29 receives the write request, it will assign the correct version number 53 to the lease In its lease list for use in subsequent access requests.

When a client modifies an existing data element 51, it will send the modified element back to the SSMC 29, which will increment the version number 53 of the appropriate lease in its lease list.

Smart Buffering

A possible and preferred embodiment of the present invention is as a component of a network block device driver that implements a smart buffering scheme. The device driver is installed on a client computer 21 that is connected to a server computer that is running SASS and is capable of responding to transactions on data elements held on the storage medium 27 connected to the server.

When an application running on the client computer 21 wishes to read a copy of a data element or data elements from the server's storage medium 27 into its local storage, it sends a request to the network block device for a copy of the data element or elements. The network block device implements a local cache of data elements and an associated list of locally-stored leases. The network block driver executes the cache invalidation algorithm described above against the local data element cache. If there exists in the local data element cache a valid copy of the requested data element or elements, then the application receives the copy of the data element or elements directly from the local data element cache rather than from the network connected server.

The network block driver is able to maintain the validity of its local data element cache by the mechanism of leases. The result of the deployment of this strategy is that new copies of the data elements are transferred across the network only when necessary. Typically, the size of a lease revalidation message is less than 10 bytes, whereas the size of a typical data element ranges from 512 bytes through many millions of bytes. The network load imposed by cache revalidation operations is therefore reduced by many orders of magnitude.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A mehod for executing a common task in a clustered computing environment comprising a plurality of computers interconnected to collaborate on said common task, said plurality of computers including at least a client computer and a shared storage medium storing data elements, said shared storage medium maintaining a main list of data version information associated with said data elements, said method comrising:
said client computer maintaining a locally-stored list containing previously retreived data elements associated with their data version;
said client computer reading from said locally-stored list data version associated with said data element and sending a request over a data network including said data version to said shared medium;
if said data version received from said client computer does not match said main list data version associated with said data element, said shared storage medium sending to said client compputer a new copy of said data element and a new data version, said client computer updating said locally-stored list with said new copy of said data element and said new data version;
if said data version received from said client computer matches said main list data version associated with said data element, said shared storage medium sending to said client computer confirmation that said locally-stored data element associated with said data version is valid;
at least one of said plurality of computers modifying said data element stored on said shared storage medium and said client computer using said retrived data element to execute said common task;
whereby transfer of copies of data elements between said shared storage medium and said plurality of computers is reduced and an amount of network load needed to retrieve data elements from said shared storage medium is reduced.

2. The method as claimed in claim 1, wherein said client sending said data version to said shared medium comprises sending a null-value data version in the case in which said data element is not stored in said client memory and said shared medium.

3. The method as claimed in claim 1, wherein said request for said data element contains an address range defining said data element on said shared medium.

4. The method as claimed in claim 3, wherein said address range comprises non-contiguous storage blocks.

5. The method as claimed in claim 1, wherein said client computer communicates with said shared medium through a network block device driver.

6. The method as claimed in claim 1, wherein said shared medium is a server memory storage space.

7. A method for maintaining a main list of data version information associated with data elements on a shared medium, said data version information being used for data retrieval, comprising:
creating a list of data structures identifying data elements on said shared medium and said data version information;
receiving a request on a data network for writing at least one of said data elements;
following modification to said at least one of said data elements, giving a new data version to said at least one of said data elements that was modified.

8. The method as claimed in claim 7, wherein if said data elements being modified are associated with multiple separate data structures containing data version information, creating a new single data structure in siad list associated with said data elements modified and removing said multiple separate data structures from said list.

9. The method as claimed in claim 7, wherein said initial version state is an initial version number and wherein said initial version number is incremented to obtain said new version state.

10. The method as claimed in claim 7, wherein said list of said structures is a double linked binary tree list.

11. A method for managing data version information associated with data elements on a shared storage medium in a clustered computing environment, said data version information being used for data retrieval by a plurality of computers interconnected in said clustered computing environment, comprising:
creating a list of data structures identifying data elements on said shared storage medium and said data version information;
receiving a request on a data network from at least one of said plurality of computers for writing at least one of said data elements;
following modifications to said at least one of said data elements, giving a new data version to said at least one of said data elements that was modified.

12. The method as claimed in claim 11, wherein if said data elements being modified are associated with multiple separate data structures containing data version information, creating a new single data structure in said list associated with said data elements modified and removing said multiple separate data structures from said list.

13. The method as claimed in claim 11, wherein said initial version state is an initial version number and wherein said initial version number is incremented to obtain said new version state.

14. The method as claimed in claim 11, wherein said list of data structures is a double linked binary tree list.
